(19) United States
(12) Patent Application Publication
(10) Pub. No.: US 2014/0347264 A1
(43) Pub. Date: Nov. 27, 2014

(54) DEVICE AND METHOD FOR DISPLAYING AN ELECTRONIC DOCUMENT USING A DOUBLE-SIDED DISPLAY

(71) Applicant: Samsung Electronics Co., Ltd., Gyeonggi-do (KR)

(72) Inventors: Yo-Han LEE, Seoul (KR); Ji-Hyun Kim, Gyeonggi-do (KR); Ji-Hea Park, Seoul (KR)

(73) Assignee: Samsung Electronics Co., Ltd., Gyeonggi-do (KR)

(21) Appl. No.: 14/148,284

(22) Filed: Jan. 6, 2014

(30) Foreign Application Priority Data
May 22, 2013 (KR) 10-2013-0057637

(51) Int. Cl. G06F 3/01

(52) U.S. Cl. CPC G06F 3/017
USPC 345/156

(57) ABSTRACT

A device and method are provided for displaying an electronic document using a double-sided display. The method includes displaying a portion of the electronic document on a first display of the double-sided display; sensing a motion of the double-sided display; and displaying another portion of the electronic document on a second display of the double-sided display, based on the sensed motion.

### PRIORITY

This application claims priority under 35 U.S.C. §119(a) to Korean Patent Application Serial No. 10-2013-0057637, which was filed in the Korean Intellectual Property Office on May 22, 2013, the entire disclosure of which is hereby incorporated by reference.

### BACKGROUND OF THE INVENTION

1. Field of the Invention

The present disclosure relates to a device and method for displaying an electronic document by using a double-sided display.

2. Description of the Related Art

A double-sided display device includes two displays disposed on opposite sides of the display device. Some double-sided displays are transparent displays. In a transparent display, two screens disposed on each side of the transparent display correspond to the two displays.

A double-sided display may be used in many different ways.

As one example, in a double-sided display in which a color display is disposed on a first side and a monochrome display is disposed on a second side, the two displays may be selectively used according to they type of content. For example, the color display may be used to display a moving or still image and the monochrome display may be used to display a book or a newspaper.

As another example, a double-sided display device may switch over a screen display between two displays disposed on both sides of a double-sided display according to a change in a three-dimensional (3D) posture of the device. For example, while displaying a screen through a first display positioned on a front side of a device, with the device is placed on a desk, if the device is turned over, the device senses such the turnover and switches the screen display to a second display positioned on a rear side of the device. Herein, when a display is positioned on a front side of a device, this means that a screen of the display faces a user, and when the display is positioned on a rear side of the device, this means that the screen of the display faces away from the user.

As an example of a screen display switchover, when a double-sided display device is turned over, a screen displaying the same content as before the turnover may be displayed on a display that is now facing the user. In this case, if the screen prior to the turnover is still displayed in the same arrangement as before the turnover, even after the turnover, the user may see the screen in which up/down or left/right arrangements are reversed. Thus, the turned-over device often changes screen display arrangements to allow the user to see the correct screen display on the newly positioned front side. Accordingly, when the double-sided display device is turned over and the screen display is switched over to display the same content as before the turnover, although both sides of the double-sided display are used, they are merely used to display a screen displaying the same content.

As another example of a screen display switchover, when the double-sided display device is turned over, different content may be displayed on the display now facing the user. For example, the screen display may be switched over to a top or sub menu screen. Also, screen display arrangements are switched over to correctly display the content on the display now facing the user. As such, even when the turned-over double-sided display device displays a screen including different content than before the turnover, although both sides of the double-sided display are used, the content displayed on the respective sides of the double-sided display have no relation therebetween, or any relation is very low.

Generally, the term “electronic document” refers to digital content of various types, which may be displayed in the form of pages, such as documents, pictures, maps, photos, books, etc., that are manufactured in digital form.

Electronic document display devices capable of displaying an electronic document, e.g., smart phones, phablets, tablet Personal Computers (PCs), electronic book readers, etc., may include double-sided displays, and display the electronic document by using the double-sided displays.

### SUMMARY OF THE INVENTION

However, like the above-described double-sided display devices, the electronic document display devices including the double-sided displays also merely use both sides of the double-sided displays to display the screens of the same contents. Further, even when the screens displaying different content are displayed on the both sides of the double-sided display, there is little or no relation between the content displayed on the two sides of the double-sided display.

Accordingly, the present disclosure has been made to at least partially solve, alleviate, or remove at least one of problems and/or disadvantages described above.

An aspect of the present invention is to provide a device and method for displaying an electronic document by using a double-sided display, in which the relation between content displayed on the two sides of the double-sided display is improved.

Another aspect of the present also invention is to provide a device and method for displaying an electronic document by using a double-sided display, which provide an experience of a 3D document form that is similar to a real document.

Another aspect of the present invention is to provide a device and method for displaying an electronic document by using a double-sided display, wherein content of the electronic document is displayed with relation on both sides of the double-sided display according to a motion of the double-sided display.

Another aspect of the present invention is to provide a device and method for displaying an electronic document by using a double-sided display, wherein content of the electronic document is displayed with relation on both sides of the double-sided display, based on a form of the electronic document, according to a motion of the double-sided display.

Other aspects to be provided in the present invention may be understood by embodiments described below.

In accordance with an aspect of the present invention, a device is provided for displaying an electronic document. The device includes a double-sided display including a first display and a second display that are disposed on opposite sides of the double-sided display and display different portions of the electronic document; a motion sensing unit configured to sense a motion of the double-sided display; and a controller configured to display a portion of the electronic document on the first display, and to display another portion of the electronic document on the second display based on a motion sensed by the motion sensing unit.

In accordance with another aspect of the present invention, a method is provided for displaying an electronic document using a double-sided display including a first display and a second display on opposite sides of the double-sided display. The method includes displaying a portion of the electronic document on the first display of the double-sided display; sensing a motion of the double-sided display; and displaying another portion of the electronic document on the second display of the double-sided display based on the sensed motion.

### BRIEF DESCRIPTION OF THE DRAWINGS

The above and other aspects, features and advantages of certain embodiments of the present disclosure will be more apparent from the following detailed description taken in conjunction with the accompanying drawings, in which:

FIG. 1 is a block diagram illustrating a device for displaying an electronic document according to an embodiment of the present invention;

FIG. 2 is a flowchart illustrating a process of displaying an electronic document using a double-sided display according to an embodiment of the present invention;

FIGS. 3A and 3B illustrate examples of screens displayed on each side of a double-sided display during a screen display switchover according to an embodiment of the present invention;

FIG. 4 is a flowchart illustrating a screen display switchover process according to an embodiment of the present invention;

FIGS. 5A and 5B illustrate examples of screens displayed on each side of a double-sided display during a screen display switchover according to an embodiment of the present invention;

FIG. 6 is a flowchart illustrating screen display switchover according to an embodiment of the present invention;

FIGS. 7A and 7B illustrate examples of screens displayed on each side of a double-sided display during a page change according to an embodiment of the present invention; and

FIG. 8 is a flowchart illustrating page change according to an embodiment of the present invention.

Throughout the drawings, like reference numerals will be understood to refer to like parts, components, and structures.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

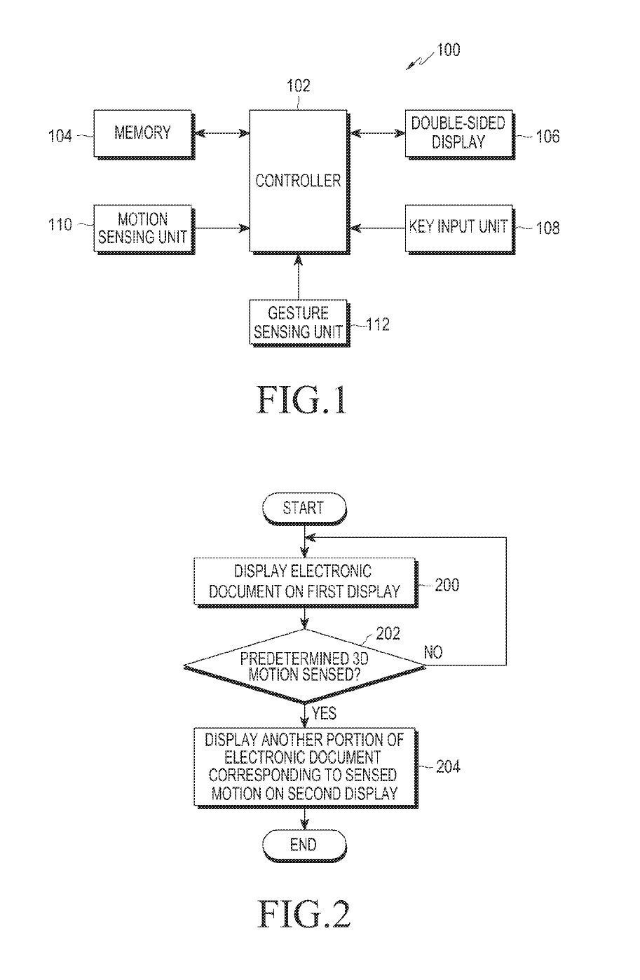

FIG. 1 is a block diagram illustrating a device for displaying an electronic document (or an electronic document display device) using a double-sided display according to an embodiment of the present invention. For example, an electronic document display device 100, as illustrated in FIG. 1, may be one of an electronic book reader, a smart phone, a phablet, a tablet PC, etc. However, the embodiments of the present invention described herein are not limited to these devices, and may be applied to any device including a double-sided display, which can be controlled according to a 3D posture change corresponding to a 3D motion of the double-sided display.

Referring to FIG. 1, the electronic document display device 100 includes a controller 102, a memory 104, a double-sided display 106, a key input unit 108, a motion sensing unit 110, and a gesture sensing unit 112. The memory 104 stores a program for operations of the controller 102 and stores various data corresponding to the operations of the controller 102. For example, the memory 104 may include an external memory and/or a storage device such as a Hard Disk Drive (HDD).

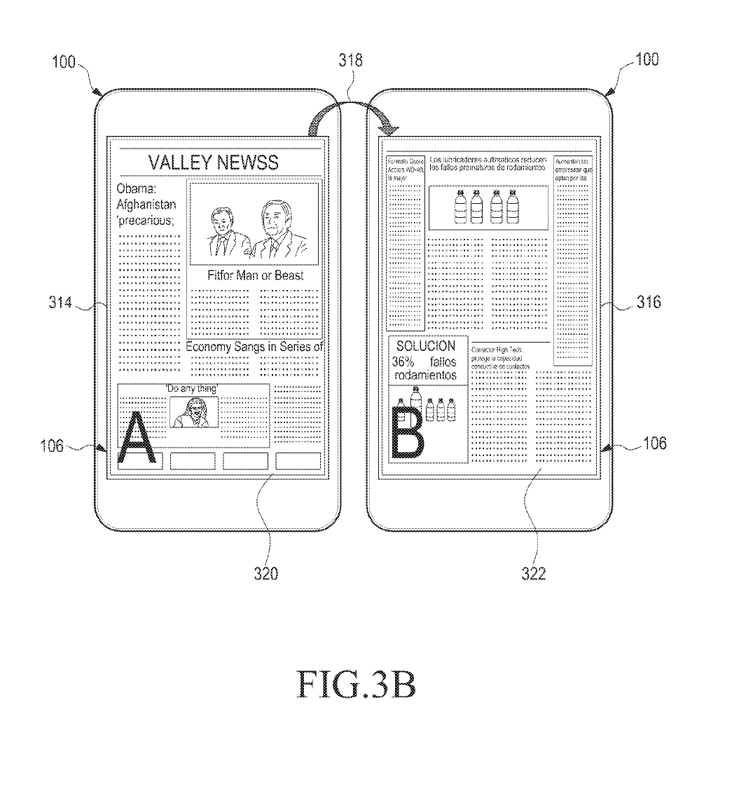

The double-sided display 106 includes a first display and a second display. Although not illustrated in FIG. 1, the first display and the second display are illustrated in FIGS. 3A, 3B, 5A, 5B, 7A, and 7B. The first display and the second display are disposed on opposite sides of the double-sided display 106 and may display different portions of an electronic document. The first display and the second display may be separate displays or an integrated display.

Additionally, a transparent display may be used as the double-sided display 106. When the transparent display is used as the double-sided display 106, the two screens disposed on the opposite sides of the transparent display correspond to the first display and the second display.

Further, a flexible display may be used as the double-sided display 106. When the flexible display is used as the double-sided display 106, the double-sided display 106 may be mounted to be bent or rolled, instead of being fixed in a body of the device 100. Further, because the flexible double-sided display 106 may then be completely bent, it is eventually in a folded state, such that bending of the double-sided display 106 may include folding. Alternatively, when the flexible double-sided display 106 is rolled, bending of the double-sided display 106 may also include rolling.

The double-sided display 106 may be a touch screen display. Generally, a touch screen display provides an input interface corresponding to a user's contact and an image output interface between a device and a user. A touch screen may be implemented in each of the first display and the second display of the double-sided display 106. When the touch screen display is used as the double-sided display 106, the first display and the second display of the double-sided display 106 display an image corresponding to an operation of the controller 102 on a screen, and provide an input corresponding to a user's contact on the screen to the controller 102. The user's contact may be made through a contact of a contact input device, such as a stylus, or a human body. The contact includes direct contact on the screen, and also an approach toward the screen, i.e., a hovering input. The contact may also include a contact that is maintained short or long or moves slowly or fast in various ways according to various gestures the user desires to input.

The key input unit 108 receives input from a user and may include various function keys such as a power button, a volume control button, etc. The key input unit 108 provides a key input corresponding to a user's manipulation with respect to function keys to the controller 102. The key input unit 108 may further include a keypad or a keyboard for inputting numeric or character information. When the double-sided display 106 includes a touch screen display, key inputs made through the key input unit 108 may be replaced with key inputs made through the double-sided display 106. In this case, all or some of the keys of the key input unit 108 may be omitted.

The motion sensing unit 110 senses a 3D motion of the double-sided display 106 and provides the sensed 3D motion to the controller 102. To sense the 3D motion of the double-sided display 106, the motion sensing unit 110 includes at least one 3D motion sensor. For example, a device such as an acceleration sensor or a camera may be used as a 3D motion sensor.

When the double-sided display 106 is made from a flexible display, the motion sensing unit 110 may also include a sensor for sensing a 3D motion, such as the bending of the double-sided display 106. Sensing a 3D motion of a device or a 3D motion, such as bending, of a flexible display by using a motion sensor mounted on the device is a general technique, and thus will not be described in detail herein.

The gesture sensing unit 112 senses a gesture on the first display and the second display of the double-sided display 106. The gesture sensed by the gesture sensing unit 112 may be, for example, a page change gesture. The gesture sensing unit 112 may include at least one of devices such as a camera and an infrared sensor to sense a contact-free gesture of the user. However, when the double-sided display 106 includes a touch screen display, the user may input a desired gesture by contacting a screen of at least one of the first display and the second display. In this case, a gesture may be sensed through the double-sided display 106 and a separate gesture sensing unit 112 may be omitted. That is, the double-sided display 106 including a touch screen display may also include the gesture sensing unit 112.

The controller 102 displays an electronic document through the double-sided display 106. More specifically, the controller 102 controls the displaying of the electronic document through the first display and the second display of the double-sided display 106 according to an input made through the double-sided display 106 or the key input unit 108, or according to sensing of the motion sensing unit 110 or the gesture sensing unit 112. For example, if the motion sensing unit 110 senses a predetermined 3D motion while displaying a portion of an electronic document on the first display, the controller 102 displays another portion of the electronic document on the second display according to the sensed motion. Likewise, if the motion sensing unit 110 senses a predetermined 3D motion while displaying a portion of an electronic document on the second display, the controller 102 displays another portion of the electronic document on the first display according to the sensed motion.

For example, the predetermined 3D motion may be a turnover of the double-sided display 106 or bending of the double-sided display 106. A type of a 3D motion and a control by the controller 102 corresponding to the 3D motion type may be set, for example, by a manufacturer of the device 100 or by a user of the device.

When the double-sided display 106 is fixed on the body of the device 100, the 3D motion of the double-sided display 106 is identical to that of the device 100. However, when the double-sided display 106 is used without being fixed to the body of the device 100, even if it is physically connected to the body of the device 100, the 3D motion of the double-sided display 106 may be different from that of the device 100. For example, bending of the double-sided display 106 as a 3D motion corresponds to when a flexible display is used as the double-sided display 106 or the device 100 including the double-sided display 106 is implemented flexibly. Considering these points, it will be described herein that the controller 102 controls the displaying through the double-sided display 106 according to a 3D motion of the double-sided display 106, not necessarily the 3D motion of the device 100.

The controller 102 controls the displaying of the electronic document through the double-sided display 106 corresponding to a gesture sensed by the gesture sensing unit 112 on the first display and the second display. Hereinafter, it will be described that the controller 102 controls page change of the electronic document when a page change gesture is sensed by the gesture sensing unit 112. An example of a general page change gesture may include left/right movement or up/down movement of a finger or a palm of a user on the screen of the display.

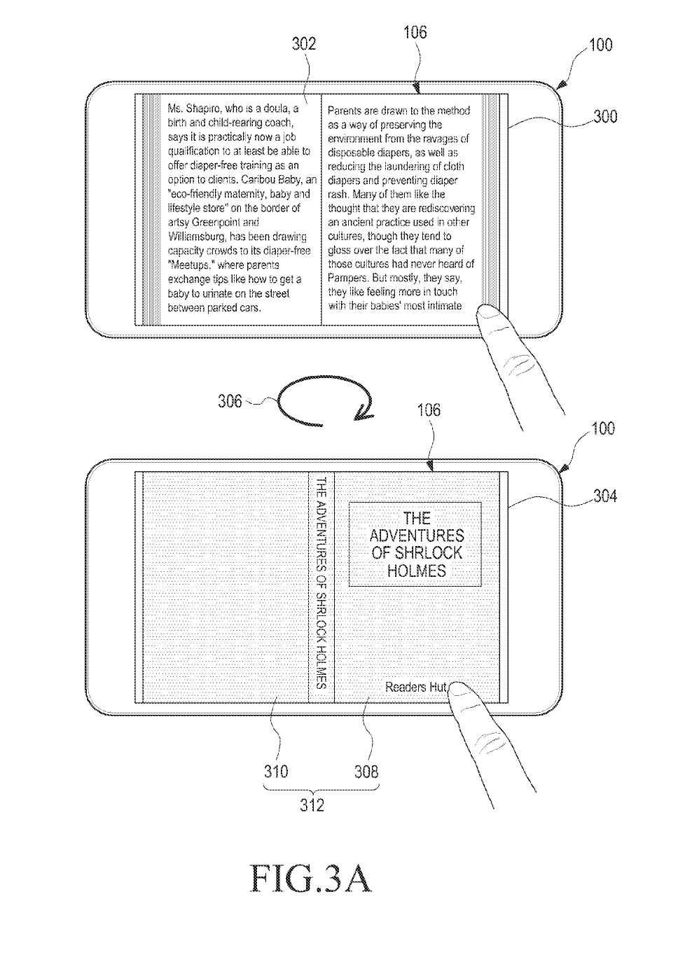

FIG. 2 is a flowchart illustrating a process of displaying an electronic document using a double-sided display according to an embodiment of the present invention. Specifically, FIG. 2 illustrates a process executed by the device 100 when a predetermined 3D motion of the double-sided display 106 is sensed while displaying the electronic document on the first display of the double-sided display 106, by way of example.

Referring to FIG. 2, the controller 102 displays an electronic document on one of the first and second displays of the double-sided display 106, for example, the first display, in step 200. When a 3D motion of the double-sided display 106 is sensed by the motion sensing unit 110, the controller 102 determines whether the sensed motion is one of predetermined 3D motions in step 202. For example, the predetermined 3D motions may include a turnover and bending as described above. If the sensed motion is one of the predetermined 3D motions in step 202, the controller 102 displays another portion of the electronic document corresponding to the sensed motion on the second display in step 204. Thus, if the double-sided display 106 is turned over or bent, a screen display switchover occurs in which another portion of the electronic document is correspondingly displayed on the second display.

FIGS. 3A and 3B illustrate examples of screens displayed on each side of a double-sided display during a screen display switchover according to embodiments of the present invention. Specifically, FIG. 3A illustrates screen display switchover where an electronic document is in the form of a book, when the double-sided display 106 is turned over. FIG. 3B illustrates screen display switchover where an electronic document is in the form of a newspaper, when the double-sided display 106 is turned over.

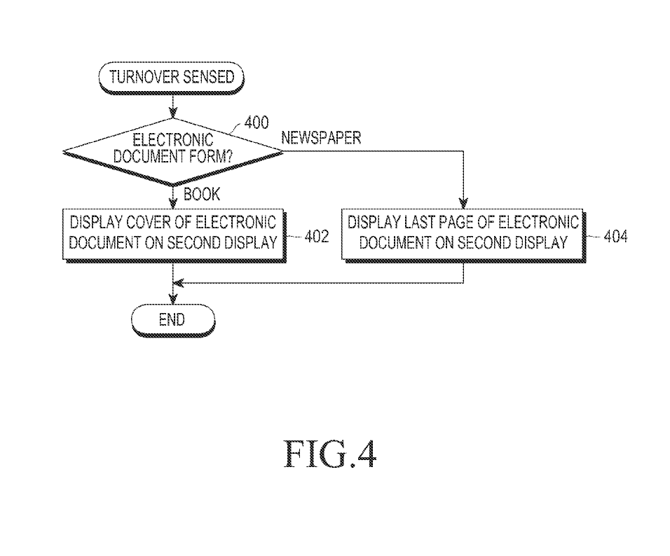

FIG. 4 is a flowchart illustrating screen display switchover according to an embodiment of the present invention. Specifically, FIG. 4 illustrates an example of a screen display switchover process executed by the device 100 when an electronic document is in the form of a book or newspaper and the double-sided display 106 is turned over.

Referring to FIG. 4, if the motion sensed in step 202 of FIG. 2 is a turnover of the double-sided display 106, the controller 102 checks a form of the electronic document in step 400. For example, the form of the electronic document may be checked from category information included in respective content. Generally, a book includes a front cover and a back cover, but a newspaper does not include a separate cover and the first page thereof corresponds to the front cover of the book and the last page thereof corresponds to the back cover of the book. In this regard, in the following description, a book and newspaper will be used as examples of forms of electronic documents.

If the controller 102 determines that the form of the electronic document is a book in step 400, the controller 102 displays the front cover and the back cover of the book on the second display in step 402.

Referring to FIG. 3A, for step 402, when out of a first display 300 and a second display 304 of the double-sided display 106, the first display 300 is initially facing the user, and displaying of a portion 302 of the electronic book, if the device 100 including the double-sided display 106 is turned over as indicated by arrow 306, then the second display 304 now faces the user. The controller 102 displays a cover 312 including a front cover 308 and a back cover 312 of the electronic book, instead of a portion 302, on the second display 304. Accordingly, as the first display 300 is not facing the user any longer, the controller 102 may end displaying through the first display 300 to preserve battery.

Thus, if the double-sided display 106 is turned over when the user of the device 100 sees a portion of the electronic document by using the device 100, the user may see a cover, instead of a portion of the content of the electronic document that the user has already seen. Hence, the user may intuitively recognize other associated portions of the electronic document and may experience a 3D book that is similar to a real book.

Alternatively, instead of displaying the cover 312 including the front cover 308 and the back cover 310, one of the front cover 308 and the back cover 310 may be displayed according to a direction of a turnover. For example, in single-page view of the electronic document, if the motion sensing unit 110 senses that the device 100 is turned over to the left, then the back cover 310 may be displayed, but if the motion sensing unit 110 senses that the device 100 is turned over to the right, then the front cover 308 may be displayed.

If the controller 102 determines that the form of the electronic document is newspaper in step 400, the controller 102 displays the last page of the newspaper on the second display in step 404.

Referring to FIG. 3B, for step 404, when out of a first display 314 and a second display 316 of the double-sided display 106, the first display 314 faces the user and displays a first page 320, as a portion of the electronic newspaper, if the device 100 including the double-sided display 106 is turned over as indicated by arrow 318, then the second display 316 now faces the user. Further, the controller 102 displays a last page 322 of the electronic newspaper on the second display 316, instead of the first page 320 of the electronic newspaper displayed on the first display 314. Accordingly, because the first display 314 is not visible to the user, the controller 102 may stop displaying through the first display 314.

Thus, if the user turns over the double-sided display 106 while seeing a portion of the electronic newspaper by using the device 100, the user may see the last page, instead of content of the electronic newspaper the user has already seen. Hence, the user may intuitively recognize other associated portions of the electronic newspaper and experience 3D newspaper that is similar to real newspaper.

Although single-page view of the electronic newspaper has been illustrated in FIG. 3B, for a double-page view, unlike in FIG. 3B in which the last cover 322 is displayed, the first page 320 and the last page 322 may be displayed on both sides.

The first display 300 and the second display 304 of FIG. 3A and the first display 314 and the second display 316 of FIG. 3B may the same as or different from each other. This is because out of two displays disposed on both sides of the double-sided display 106, a display positioned on the front side prior to a turnover is referred to as a first display and a display positioned on the rear side prior to a turnover is referred to as a second display. Thus, the two displays disposed on the both sides of the double-sided display 106 may be the first display or the second display according to their positions.

As described above, according to an embodiment of the present invention, if a 3D position is changed according to a 3D motion of the double-sided display 106, the content of an electronic document is displayed with relation on the two sides of the double-sided display 106. In this case, depending on a form of the electronic document, different content of the electronic document are displayed with relation on the two sides of the double-sided display 106. Hence, relation between content displayed on the two sides of the double-sided display 106 is improved, thus providing an experience of a 3D document that is similar to a real document for the electronic document to the user.

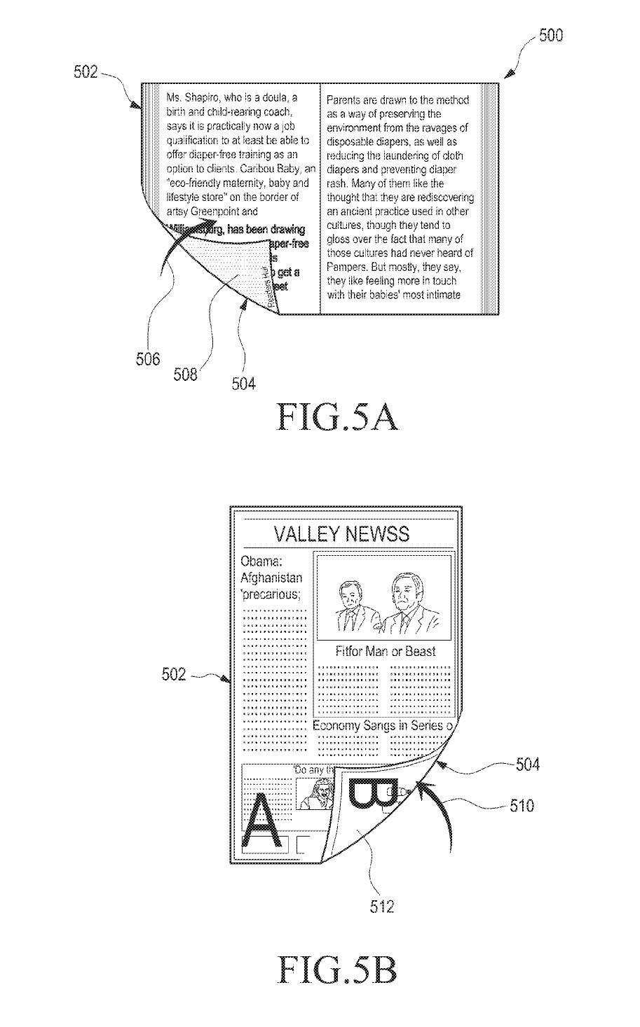

FIGS. 5A and 5B illustrate examples of screens displayed on each side of a double-sided display during a switchover according to an embodiment of the present invention. Specifically, FIG. 5A illustrates an example of screen display switchover in which a double-sided display 500 is a flexible display, and an electronic document is in the form of a book, when the double-sided display 500 is bent toward a first display 502. FIG. 5B illustrates an example of screen display switchover in which the double-sided display 500 is a flexible display, and the electronic document is in the form of newspaper, when the double-sided display 500 is bent toward the first display 502. The double-sided display 500 has been denoted by reference numeral 500 to indicate that it is a flexible display, different from the double-sided display 106 that is fixed on the device 100, as illustrated in FIGS. 3A and 3B.

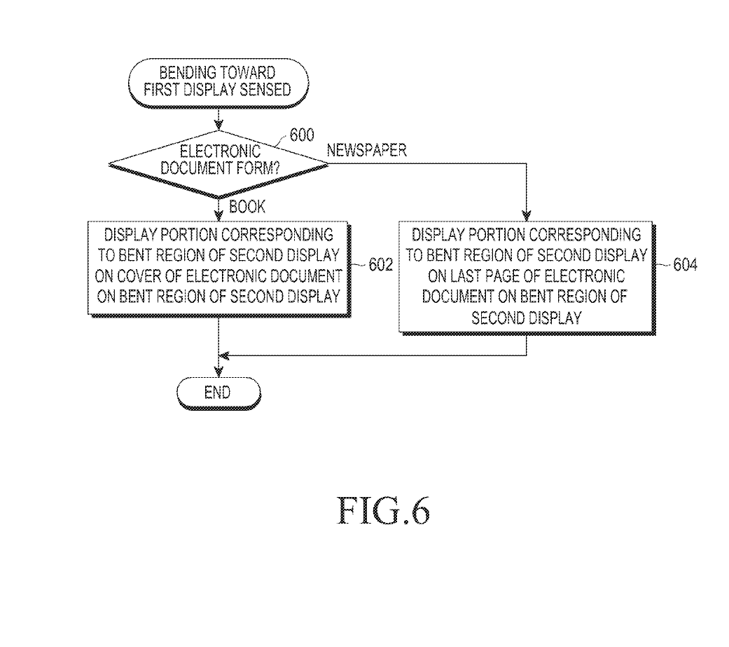

FIG. 6 is a flowchart illustrating a screen display switchover according to an embodiment of the present invention. Specifically, FIG. 6 illustrates an example of a screen display switchover process executed by the device 100 when an electronic document is in the form of a book or newspaper and the double-sided display 500, which is a flexible display, is bent.

Referring to FIG. 6, if the motion sensed in step 202 of FIG. 2 is the bending of the double-sided display 500 toward the first display 502, the controller 102 checks a form of the electronic document in step 600.

If the controller 102 determines that the form of the electronic document is a book in step 600, the controller 102 displays a portion corresponding to a bent region of the second display on the cover of the electronic document on the bent region of the second display in step 602.

Referring to FIG. 5A, in step 602, when out of a first display 502 and a second display 504 of the double-sided display 500, the first display 502 faces the user and a portion of the electronic book on two pages sides, if the double-sided display 500 is bent toward the first display 502 as indicated by arrow 506, then the controller 102 displays a portion corresponding to the bent region 508 of the second display on the bent region 508 of the second display.

Thus, when the user of the device 100 sees a portion of an electronic book by using the device 100, if the user bends a portion of the double-sided display 500, the user sees a portion of a cover, instead of contents of the electronic book the user was viewing on the first display 502. Hence, the user may intuitively recognize other associated portions of the electronic book and experience a 3D document that is similar to a real document.

Alternatively, for single-page view of the electronic book, unlike in FIG. 5A in which a portion of a front cover is displayed on the bent region 508 of the second display, one of a portion of the front cover and a portion of a back cover may be displayed according to a direction of bending. For example, in single-page view of the electronic book, if the motion sensing unit 110 senses that the double-sided display 500 is folded to the right, a portion of the back cover may be displayed; if the motion sensing unit 110 senses that the double-sided display 500 is folded to the right, a portion of the front cover may be displayed.

Referring again to FIG. 6, if the controller 102 determines that the form of the electronic document is newspaper in step 600, the controller 102 displays a portion of the last page of the electronic document corresponding to the bent region of the second display on the bent region of the second display in step 604.

Referring to FIG. 5B, in step 604, when out of the first display 502 and the second display 504 of the double-sided display 500, the first display 502 faces the user and a portion of the electronic newspaper is displayed on a single page, if the double-sided display 500 is bent toward the first display 502 as indicated by arrow 510, then the controller 102 displays a portion of the last page of the electronic document corresponding to a bent region 512 of the second display on the bent region 512 of the second display.

Thus, when the user of the device 100 sees a portion of the electronic newspaper by using the device 100, if the user bends a portion of the double-sided display 500, the user now sees a portion of the last page of the electronic newspaper, instead of the content of the electronic newspaper that the user has already seen. Hence, the user may intuitively recognize other associated portions of the electronic newspaper and experience 3D newspaper that is similar to real newspaper.

Although single-page view is used as an example for electronic newspaper in FIG. 5B, for a double-page view of the electronic newspaper, one of a portion of the first page and a portion of the last page may be displayed according to a direction of bending. For example, in a single-page view of the electronic newspaper, if the motion sensing unit 110 senses that a right side of the double-sided display 500 is folded to the left, a portion of the last page may be displayed, but if the motion sensing unit 110 senses that a left side of the double-sided display 500 is folded to the right, a portion of the first page may be displayed.

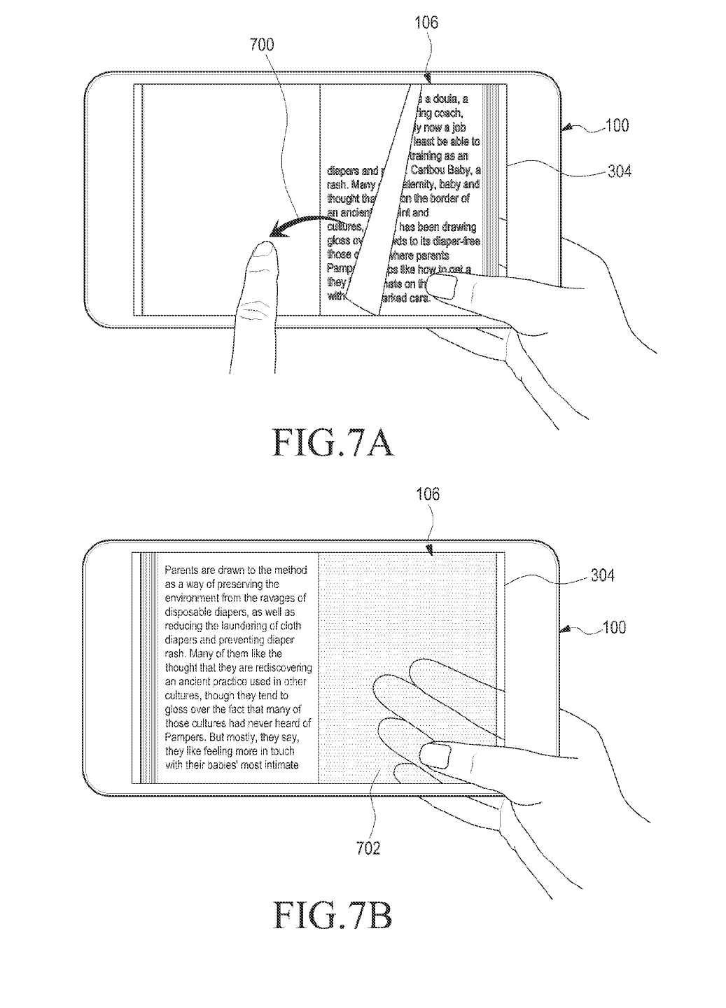

FIGS. 7A and 7B illustrate examples of screens displayed on each side of a double-sided display during a page change according to an embodiment of the present invention. Specifically, FIGS. 7A and 7B illustrate an example of page change in which an electronic document is in the form of a book (similar to FIG. 3A), while displaying of the book on the first display 300 of the double-sided display 106 in a double-page view, where the screen display is switched over to the second display 304 by a turnover of the double-sided display 106, and thereafter, a page change gesture is sensed. FIGS. 7A and 7B illustrate an example in which the double-sided display 106 is a transparent display.

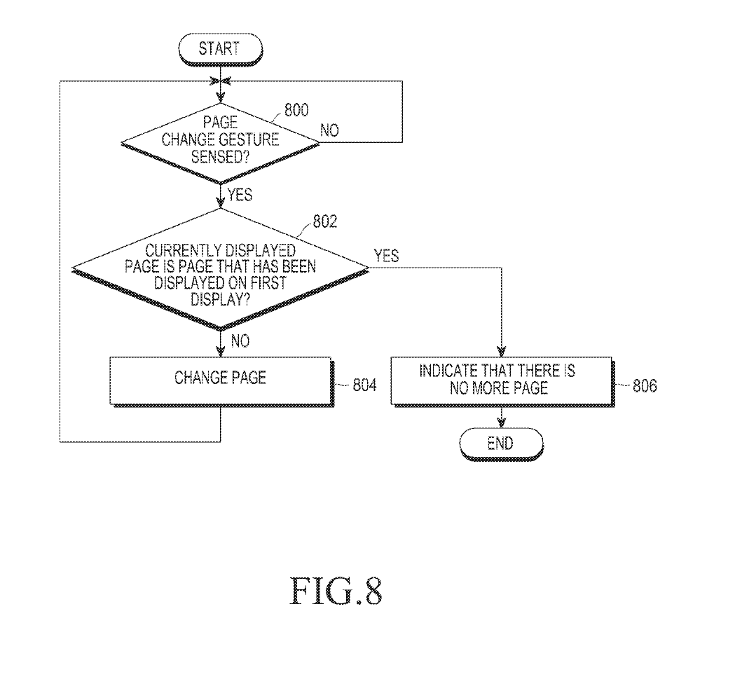

FIG. 8 is a flowchart illustrating a page change process according to an embodiment of the present invention. Specifically, FIG. 8 illustrates an example of a page change process during a display of an electronic document on the first display 300 of the double-sided display 106, where the double-sided display 106 is turned over, such that the screen display is switched over to the second display 304, and thereafter, a page change gesture is sensed.

Referring to FIG. 8, in step 800, each time a page change gesture 700 is sensed by the gesture sensing unit 112, the controller 102 performs steps 802 through 806 to change a page of the electronic document on the second display 304 or determine that there are no more pages. More specifically, if the page change gesture 700 is sensed by the gesture sensing unit 112 in step 800, the controller 102 determines whether the currently displayed page on the second display 304 is a page that has been displayed on the first display 300 prior to a turnover of the double-sided display 106.

If the currently displayed page on the second display 304 is not the page that has been displayed on the first display 300 prior to the turnover of the double-sided display 106, the controller 102 changes a page of the electronic document on the second display 304 in step 804, as illustrated in FIG. 7A. However, if the currently displayed page on the second display 304 is a page that has been displayed on the first display 300 prior to the turnover of the double-sided display 106, then the controller 102 indicates that there are no more pages in step 806, as illustrated in FIG. 7B. For example, the controller 102 may indicate that there are no more pages by displaying no page on a portion 702 where a changed page is to be displayed, as illustrated in FIG. 7B. As another example, the controller 102 may display a phrase indicating that there are no more pages. The controller 102 may also output a voice message or audible tone indicating that there are no more pages.

Therefore, the user may be provided with an experience of a 3D document that is similar to a real document.

While the present invention has been particularly illustrated and described with reference to certain embodiments thereof, various modifications or changes can be made without departing from the scope of the present invention.

For example, although a book and newspaper have been described as examples of forms of electronic documents, embodiments of the present invention are not limited to these two forms of electronic documents. That is, those of ordinary skill in the art may easily understand that for another form of an electronic document, the embodiments of the present invention may be applied equally or at least in a similar way from the foregoing description. For example, if the form of the electronic document is a picture, screen display switchover may be performed by displaying a memo written on a rear side of the picture according to a 3D motion such as a turnover or bending of the double-sided display.

Moreover, it has been described that the embodiments of the present invention are applied to display an electronic document, but the embodiments may also be applied to digital content of other forms as well as an electronic document. For example, when video is displayed on one of two sides of the double-sided display in a video play device, by turning over the double-sided display, the play point in time may be changed into the first play point of the video.

If the methods for displaying an electronic document according to the embodiments of the present invention are applied to a mobile terminal, the mobile terminal may be used for displaying an electronic document by downloading a program (for example, an application) for electronic document display from a program providing apparatus (for example, a server) located in a remote place or installing the program and executing the program. That is, if the program for electronic document display is installed on the mobile device, the program may be executed on the mobile device to provide electronic document display. The program providing device transmits the program to the mobile device in response to a request for transmission of the program from the mobile device or automatically. The program providing device may additionally perform service subscription determination, user authentication, and payment information checking with respect to the mobile device. The program providing device may include a communication unit for performing wired or wireless communication with the mobile device, a storage medium for storing the program, and a controller for transmitting the program to the mobile device through the communication unit. The storage medium may be located inside or outside the program providing device.

The embodiments of the present invention may be implemented with hardware, software, or a combination of hardware and software. Such arbitrary software may be stored, whether or not erasable or re-recordable, in a volatile or non-volatile storage such as a memory such as a Random Access Memory (RAM), a Read-Only Memory (ROM), or an integrated circuit; and an optically or magnetically recordable and machine (e.g., computer)-readable storage medium such as a Compact Disc (CD), a Digital Versatile Disk (DVD), a magnetic disk, or a magnetic tape. The displaying an electronic document method according to the present disclosure may be implemented by a computer or a portable terminal which includes a controller and a memory, and the memory is an example of a machine-readable storage medium which is suitable for storing a program or programs including instructions for implementing the embodiment of the present disclosure. Therefore, the present invention includes a program including codes for implementing an apparatus or method claimed in an arbitrary claim and a machine-readable storage medium for storing such a program. The program may be electronically transferred through an arbitrary medium such as a communication signal delivered through wired or wireless connection, and the present invention properly includes equivalents thereof.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A device for displaying an electronic document, the device comprising:
a double-sided display including a first display and a second display that are disposed on opposite sides of the double-sided display and display different portions of the electronic document;
a motion sensing unit configured to sense a motion of the double-sided display; and
a controller configured to display a portion of the electronic document on the first display, and to display another portion of the electronic document on the second display based on a motion sensed by the motion sensing unit.

2. The device of claim 1, wherein the controller is configured to display a cover of the electronic document on the second display, if the sensed motion is a turnover of the double-sided display.

3. The device of claim 2, further comprising a gesture sensing unit configured to sense a gesture,
wherein the controller is configured to sequentially change a page of the electronic document that is displayed, based on the sensed gesture, and to output an indication that there are no further pages when a page of the electronic document that has been displayed on the first display has been reached.

4. The device of claim 1, wherein the controller is configured to display a last page of the electronic document on the second display, if the sensed motion is a turnover of the double-sided display.

5. The device of claim 4, further comprising a gesture sensing unit configured to sense a gesture,
wherein the controller is configured to sequentially change a page of the electronic document that is displayed, based on the sensed gesture, and to output an indication that there are no further pages when a page of the electronic document that has been displayed on the first display has been reached.

6. The device of claim 1, wherein the controller is configured to display a portion of a cover of the electronic document corresponding to a region of the second display that is bent toward the first display, on the bent region of the second display, if the sensed motion is a bending of the double-sided display toward the first display.

7. The device of claim 1, wherein the controller is configured to display a portion of a last page of the electronic document corresponding to a region of the second display that is bent toward the first display, on the bent region of the second display, if the sensed motion is a bending of the double-sided display toward the first display.

8. A method for displaying an electronic document using a double-sided display including a first display and a second display on opposite sides of the double-sided display, the method comprising:
displaying a portion of the electronic document on the first display of the double-sided display;
sensing a motion of the double-sided display; and
displaying another portion of the electronic document on the second display of the double-sided display based on the sensed motion.

9. The method of claim 8, wherein displaying the another portion of the electronic document comprises displaying a cover of the electronic document on the second display, if the sensed motion includes a turnover of the double-sided display.

10. The method of claim 9, further comprising:
sensing a gesture input from a user;
sequentially changing a page of the electronic document that is displayed, based on the sensed gesture; and
outputting an indication that there are no further pages when a page of the electronic document that has been displayed on the first display has been reached.

11. The method of claim 8, wherein displaying the another portion of the electronic document comprises displaying a last page of the electronic document on the second display, if the sensed motion includes a turnover of the double-sided display.

12. The method of claim 11, further comprising:
sensing a gesture input from a user;
sequentially changing a page of the electronic document that is displayed, based on the sensed gesture; and
outputting an indication that there are no further pages when a page of the electronic document that has been displayed on the first display has been reached.

13. The method of claim 8, wherein displaying the another portion of the electronic document comprises displaying a portion of a cover of the electronic document corresponding to a region of the second display that is bent toward the first display, on the bent region of the second display, if the sensed motion includes a bending of the double-sided display toward the first display.

14. The method of claim 8, wherein displaying the another portion of the electronic document comprises displaying a portion a last page of the electronic document corresponding to a region of the second display that is bent toward the first display, on the bent region of the second display, if the sensed motion includes a bending of the double-sided display toward the first display.
